(19) United States
(12) Patent Application Publication
(10) Pub. No.: US 2025/0114800 A1
(43) Pub. Date: Apr. 10, 2025

(54) REMOVABLY ATTACHABLE SKIMMING MECHANISM

(71) Applicant: DHI - DALBO HOLDINGS, INC. & SUBSIDIARIES, Salt Lake City, UT (US)

(72) Inventors: Gary J. COATES, The Woodlands, TX (US); Herron J. KENNEDY, Ocean Springs, MS (US)

(73) Assignee: DHI - DALBO HOLDINGS, INC. & SUBSIDIARIES, Salt Lake City, UT (US)

(21) Appl. No.: 18/377,584

(22) Filed: Oct. 6, 2023

(51) Int. Cl. B03D 1/14

(52) U.S. Cl. CPC B03D 1/1487; B03D 1/1431

(57) ABSTRACT

A skimming mechanism for treating fluid includes a removably attachable frame and a conveyor traversing a length of the frame. The frame is removably attachable from a dissolved air flotation tank. The conveyor includes a chain and at least one scraper blade.

### BACKGROUND

In a dissolved air flotation (“DAF”) system, dissolved air is mixed with a fluid, causing waste in a DAF tank to rise to a surface of the fluid. A skimming mechanism then skims the surface of the fluid, collecting the waste, for example, into a waste compartment for removal from the system.

The skimming mechanism contains many moving components, such as a conveyor with a chain. By the nature of these moving components, if a part of the skimming mechanism were to break or fail, it could result in a series of breaks or failures of other parts. Thus, the manufacturing of the skimming mechanism requires a high level of precision and skill. In comparison, manufacturing of the DAF tank itself requires a lower degree of precision and skill. When the skimming mechanism and DAF tank are integrated, assembly with a high degree of skill is necessary for the entirety of the unit given that the skimming mechanism and DAF tank are manufactured together.

In addition, skimming mechanisms require regular or routine maintenance. During maintenance of the skimming mechanism, in such integrated configurations, the DAF tank may be taken offline for a technician to access the skimming mechanism, often from inside of the DAF tank. This may require operational downtime of the DAF tank for up to an entire day.

Further, fluids being treated by the DAF unit that are placed into contact with the skimming mechanism are typically highly corrosive. As such, components of the skimming mechanism must exhibit high corrosion resistance. Other parts of the DAF unit may see less interaction with the corrosive fluids.

In a configuration where the DAF tank and the skimming mechanism are integrated into a single, indivisible unit, the DAF tank may be built to the standard of the skimming mechanism in an effort to match the expected life time of the DAF tank to that of the skimming mechanism. Thus, in such a configuration, the DAF tank is often composed of similar materials with a high corrosion resistance. If the DAF tank and the skimming mechanism are not composed of similar materials, they may have different lifetime expectancies. In such a situation, due to their integrated nature, a failure of either the DAF tank or the skimming mechanism could result in a total loss of both units, even if one of the units maintains functionality.

### SUMMARY

In one aspect, this disclosure provides a removably attachable skimming mechanism that eliminates these drawbacks. For example, some embodiments relate to a skimming mechanism that is removably attachable to a remainder of a DAF tank. Such a configuration may allow for the complicated assembly of the skimming mechanism to be manufactured separately from the DAF tank and later joined once manufacture of both assemblies are complete or at another desirable time. This can advantageously provide for cost savings and efficiencies in manufacturing because the skill level required to manufacture the skimming mechanism is higher than that of the DAF tank. Thus, workers of different skill levels can separately and more efficiently manufacture their respective components.

Further, the configuration can allow for the skimming mechanism to be detached and, if necessary, entirely removed from the DAF tank, for example in the case of routine or scheduled maintenance.

In one aspect, the disclosure provides a skimming mechanism for treating fluid, the skimming mechanism comprising a frame configured to be removably attachable from a dissolved air flotation tank and a conveyor traversing a length of the frame, the conveyor including a chain and at least one scraper blade connected to the chain.

In another aspect, the disclosure provides a dissolved air flotation system comprising a dissolved air flotation tank, a skimming mechanism including, a frame configured to be removably attachable from the dissolved air flotation tank, an alignment mechanism provided on a surface of the frame, the alignment mechanism configured to align the frame with the dissolved air flotation tank at a while that the frame and the dissolved air flotation tank are in an attached configuration, and a conveyor traversing a length of the frame, the conveyor including a chain and at least one scraper blade connected to the chain, a motor configured to rotate the conveyor and drive the at least one scraper blade across the length of the frame, a mating mechanism disposed on a surface of the dissolved air flotation tank, the mating mechanism configured to mate with the alignment mechanism of the frame at a time while the frame and the dissolved air flotation tank are in the attached configuration, and a waste compartment joined to the dissolved air flotation tank.

### BRIEF DESCRIPTION OF THE DRAWINGS

FIG. 1 is a top perspective view of a removably attachable skimming mechanism according to an embodiment of the present disclosure;

FIG. 2 is a top plan view thereof;

FIG. 3 is a side view thereof;

FIG. 4 is a top perspective view of a removably attachable skimming mechanism at a time that the attachable skimming mechanism and a dissolved air flotation tank are in an attached configuration according to an embodiment of the present disclosure;

FIG. 5 is a side view thereof;

FIG. 6 is a cross-sectional view taken on line A-A of FIG. 4;

FIG. 7 is a flowchart of a method according to some embodiments; and

FIG. 8 is a flow chart of a method for leveling a removably attachable skimming mechanism according to some embodiments.

### DETAILED DESCRIPTION OF EMBODIMENTS

In the following description, numerous details are set forth to provide an understanding of the present disclosure. However, it may be understood by those skilled in the art that the devices and methods of the present disclosure may be practiced without these details and that numerous variations or modifications from the described embodiments may be possible.

As referred to herein, the term “fluid” may be wastewater, clean water, or sludge, oil, some other fluid transiting through at least some part of the dissolved air flotation system described herein.

As referred to herein, the term “waste” may be sludge, grime, particulate matter, suspended solids, oils, greases, contaminants, or other matter being separated from the fluid in the dissolved air flotation system described herein.

As referred to herein, the term “attached configuration” identifies a configuration whereby the DAF tank and the skimmer are connected, either via direct or indirect contact, to each other. The term “detached configuration” is one where the skimmer and DAF tank are separated in some manner, which may be when the DAF system is undergoing maintenance to one or more components, transport, or otherwise is not functioning with the DAF tank and skimmer as an integrated unit.

Embodiments herein refer to method and systems used in the treatment of a fluid, such as wastewater. The treatment may occur during, for example, a hydraulic fracturing process for extracting oil or gas, or another treatment for acquiring or otherwise treating a fluid

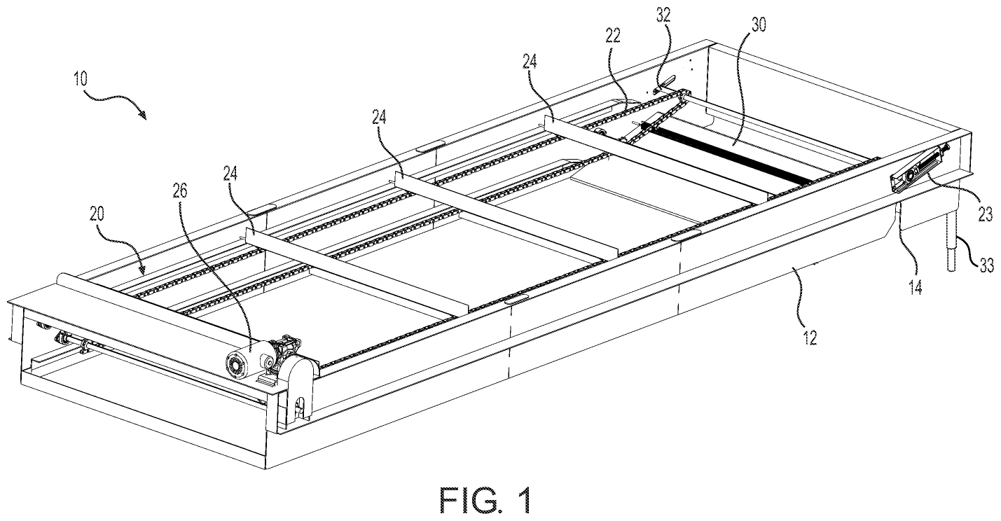

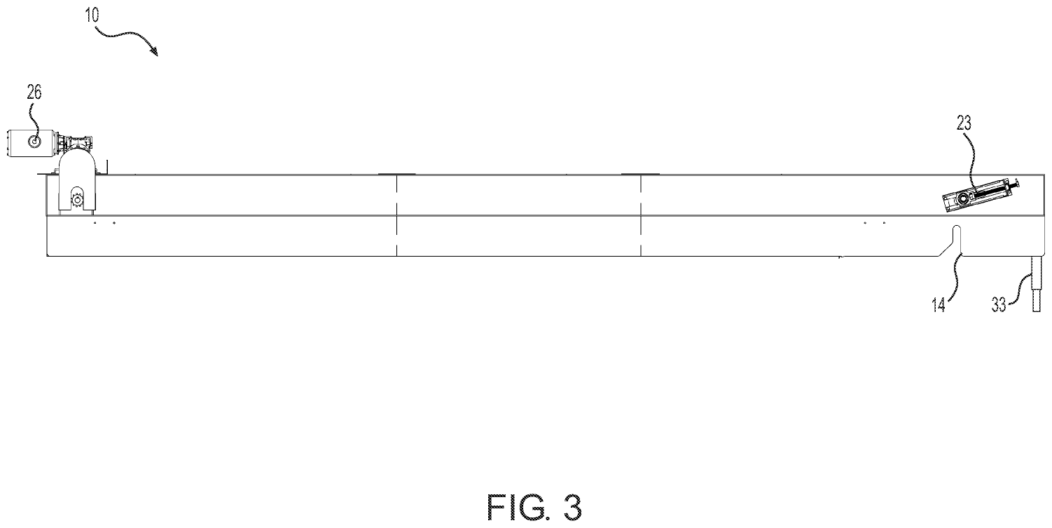

FIGS. 1-3 illustrate a removably attachable skimming mechanism 10. The removably attachable skimming mechanism 10 includes a frame 12 with a conveyor 20 traversing a length of the frame 12. The conveyor includes a chain 22 connected to a plurality of scraper blades 24.

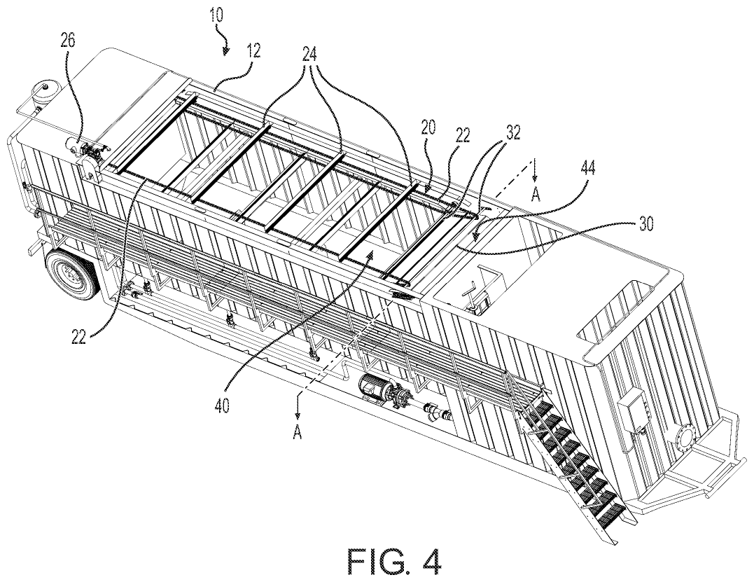

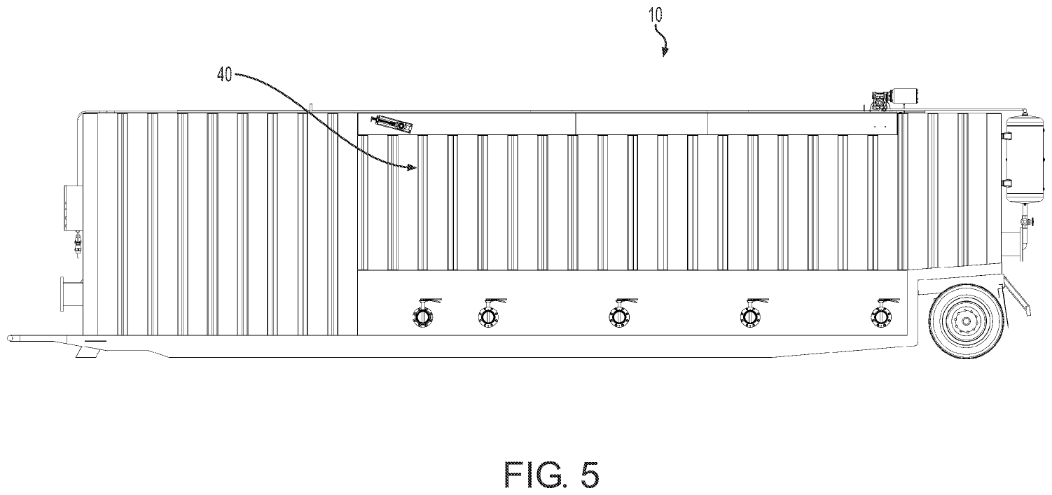

FIGS. 4-6 illustrate the removably attachable skimming mechanism 10 removably attached to a DAF tank 40. The DAF tank 40 is joined next to a waste compartment 44.

The scraper blades 24 are configured to transport waste across a surface of a fluid in the DAF tank 40 at some time while the frame 12 and the DAF tank 40 are in the attached configuration. For example, the scraper blades 24 may transport waste by skimming the waste across a length of the frame 12 towards the waste compartment 44. The scraper blades 24 may travel just below or at a surface level of a fluid in the DAF tank 40.

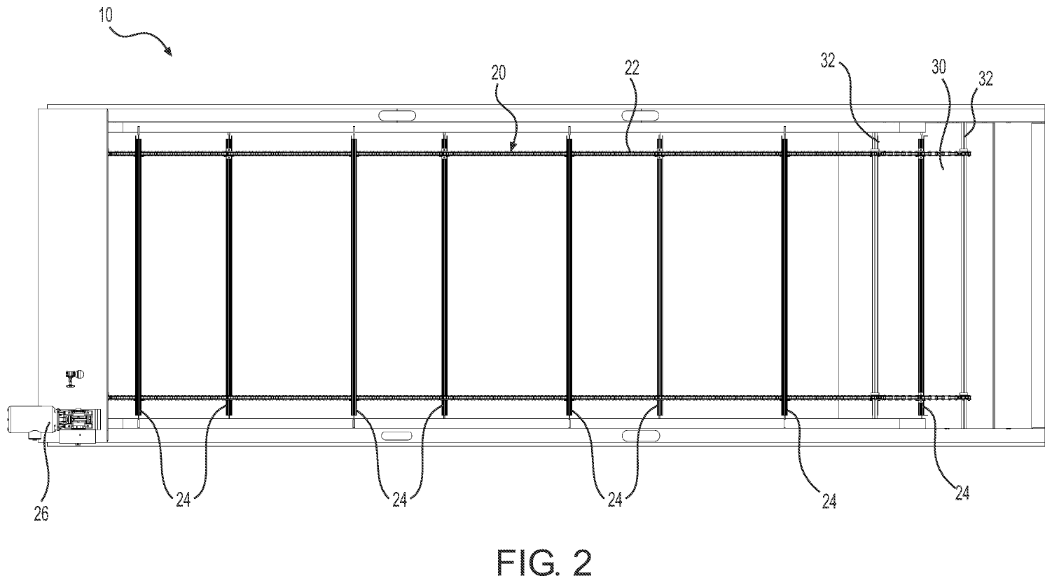

As shown in FIGS. 1-3, the scraper blades 24 may be provided as flat appendages that extend across a width of the frame 12, from a first end of the frame 12 to a second end of the frame 12. The width of the frame 12 is traverse to the length of the frame 12, and thus, the scraper blades 24 extend essentially perpendicularly with respect to the length of the frame 12 and are configured to traverse across the extent of the conveyor 20. In some embodiments, the scraper blades 24 may only be configured to travel across a fraction of the length of the conveyor 20. The size and/or shape of the scraper blades 24 are not particularly limited. For example, the scraper blades may be a scoop, a bucket, a shovel, a net, a mesh, a hand, a rake, a claw, or a plow. While FIGS. 1 and 2 show a plurality of scraper blades 24, the number of scraper blades 24 is not particularly limited. For example, some embodiments may include a skimming mechanism 10 with only one scraper blade 24, or two or more, or three or more, four or more, and so on. In addition, the scraper blades 24 need not necessarily extend across an entire width of the frame 12, but may extend only across, for example, a partial width of the frame. In some embodiments, the scraper blades 24 may extend obliquely with respect to the width of the frame 12, and thus, may not be perpendicular with respect to the length of the frame 12.

The frame 12 may include a beach 30. The beach 30 may provide a surface to separate the waste transported by the scraper blades 24 from the fluid. In some embodiments, the waste is dried when crossing the surface of the beach 30. The beach 30 may be disposed at a predetermined distance from a surface of the frame 12 that is located at a side end of the frame 12. The predetermined distance may be in a range of 1 inch to 60 inches, 6 inches to 40 inches, or 12 inches to 30 inches.

The predetermined distance may correspond to an open space between the beach 30 and the surface of the frame 12 that is located at the side end of the frame 12. The open space may be configured to receive waste transported by the scraper blades 24 across the beach 30. Waste may travel through the open space to enter the waste compartment 44.

The beach 30 may include or be a ramped surface. The ramped surface may extend away from a surface of the fluid in the DAF tank 40. The ramped surface may also extend toward the surface of the frame 12 that is located at a side end of the frame 12. The ramped surface of the beach 30 may provide a route for the waste to travel across, toward the open space from the surface of the fluid. The ramped surface of the beach 30 may assist in drying the waste by providing a runway for fluid to drain from the waste.

At least one shaft 32 may extend across a width of the frame 12. The at least one shaft 32 may extend across an entire width of the frame 12 or a fraction of the width of the frame 12. The chain 22 may be connected to the at least one shaft 32, such that the at least one shaft 32 directs a course or a path of the chain 22 and the scraper blades 24. For example, the chain 22 and scraper blades 24 may change direction at a location of the at least one shaft 32 when the chain 22 is rotated by a motor 26. The at least one shaft 32 may function as a fulcrum or an axle for the chain 22. The at least one shaft 32 may be disposed on a side of the beach 30 opposite of the fluid at a time that the frame 12 and the DAF tank 40 are in the attached configuration. The position of the at least one shaft 32 relative to the beach 30 may cause the scraper blades 24 to travel across the ramped surface of the beach 30 at an angle corresponding to the angle of the ramped surface. In some embodiments, the angle of the ramped surface relative to the frame 12 may be adjustable. In some embodiments, the length of the beach 30 may be adjustable across a length of the frame 12.

A tensioner 23 may be connected to the frame 12. The tensioner 23 may adjust or manipulate a tension of the chain 22. The tensioner 23 may be an automatic tensioner which applies constant tension to the chain 22, for example, by way of a spring. The tensioner 23 may also be operated by a user. The user may operate the tensioner 23 to relieve or apply tension to the chain 22, for example, during maintenance of the skimming mechanism 10.

The number of chains 22 in the skimming mechanism 10 is not particularly limited. For example, in some embodiments, there may be a single chain 22. Alternatively, a plurality of chains 22 may be utilized. The configuration of the chains 22 is not particularly limited. As shown in FIGS. 1-2, each chain 22 extends across a respective side of the frame 12. However, the chain 22 may extend across only a portion of a side of the frame 12, multiple sides of the frame 12, or a perimeter of the frame 12.

The motor 26 may be attached to the frame 12 and configured to drive the chain 22 and the scraper blades 24 across the length of the frame 12, for example by rotating the chain 22. The motor 26 may be paired with a gear reducer to lower a motor speed. When powered by the motor 26, the scraper blades 24 may traverse the frame 12 at a speed of approximately 0.1-36 inches per second, 1-12 inches per second, or 2-8 inches per second.

In some embodiments, the motor 26 may be attached to the DAF tank 40 and configured to drive the conveyor 20 at some time that the frame 12 and the DAF tank 40 are in the attached configuration.

At least one leveling jack 33 may be included at an edge of the frame 12. For example, as shown in FIG. 1, the at least one leveling jack 33 is disposed in at least one corner of the frame 12. The positioning of the at least one leveling jack 33 is not limited to a corner and may be at a side or end of the frame 12. Alternatively, the at least one leveling jack 33 may be disposed at any position between the frame 12 and the DAF tank 40, at a time that the frame 12 and the DAF tank 40 are in the attached configuration. Thus, the at least one leveling jack 33 may press against the DAF tank 40 to adjust a height at one end of the frame 12 with respect to the DAF tank 40.

The at least one leveling jack 33 may orient the frame 12 with respect to a surface of the fluid in the DAF tank 40, at some time that the frame 12 and the DAF tank 40 are in the attached configuration. The at least one leveling jack 33 may be any jack capable of raising and/or lowering at least one end of the frame 12. The at least one leveling jack 33 is not particularly limited and may be, for example, a scissor jack, a house jack, a hydraulic jack, or a pneumatic jack, a threaded bolt or screw, and/or a telescoping leg and pin.

A user and/or a controller may operate the at least one leveling jack 33 to raise or lower a height of the frame 12 with respect to the DAF tank 40. For example, the user or the controller may measure the level of the frame 12 by way of a leveling device, such as a bubble level, a digital level, or a laser level. The at least one leveling jack 33 may then be adjusted to raise or lower the height of the frame 12. The controller or the user may then measure the level of the frame 12 again with the leveling device. Alternatively, the device may be leveled based on a visual estimate. This process may continue until the level of the frame 12 is within an acceptable range. The acceptable range may be in the range of −10° to +10°, −5° to +5°, −3° to +3°, or −1° to +1°. In some embodiments, the at least one leveling jack 33 may be operated when the DAF tank is full of fluid. In said embodiments, the acceptable range may be a level of the skimming mechanism in which the scraper blades 24, when operated by the motor 26, traverse the surface of the fluid in the DAF tank or traverse just below the surface of the fluid of the DAF tank. This may allow for alignment between the DAF tank 40 and the skimming mechanism 10 and/or orienting the skimming mechanism 10 in a desirable position with respect to either the DAF tank 40 or a fluid in the DAF tank 40, even when the DAF tank and skimmer are made to be detachable from each other.

The at least one leveling jack 33 may allow for alignment of the skimming mechanism 10 and/or orienting the skimming mechanism 10 into a suitable position for operation of the DAF unit without adjusting the, typically, larger and heavier DAF tank 40, even when the DAF tank 40 and skimming mechanism 10 are made to be removably attachable from each other.

Some embodiments may include a skimming mechanism 10 with at least one leveling jack 33, two or more, or three or more, four or more, and so on. For example, a single leveling jack 33 may be positioned at one side of the frame 12. The single leveling jack 33 may then raise or lower that side of the frame 12. Alternatively, in some embodiments, a leveling jack 33 may be positioned at least ones side or corner of a frame 12. In such embodiments, each leveling jack 33 may be raised or lowered to adjust a respective height of each side or corner of the frame 12.

In some embodiments, the at least one leveling jack 33 may be configured to adjust a height of at least one end or corner of the conveyor 20 with respect to the frame 12. In such configurations, the at least one leveling jack 33 may be disposed between the conveyor 20 and the frame 12. For example, the conveyor 20 may be affixed to the frame 12 in such a manner that enables corners or sides of the conveyor 20 to be raised or lowered with respect to the frame 12 by the at least one leveling jack 33. As described herein, the architecture, functionality, and/or operation for leveling the height of the frame 12 with respect to the height of the DAF tank may also apply to leveling the height of the conveyor 20 with respect to the height of the frame 12.

The motor 26 may removably attach to a power supply. For example, the motor 26 may removably attach to the power supply at some time while the frame 12 and the DAF tank 40 are in the attached configuration. Thus, power may be delivered to the motor 26 for operation. The motor 26 may detach from the power supply, for example, before detaching the removably attachable skimming mechanism 10 from the DAF tank 40. This enables detachment of the frame 12 from the DAF tank 40 without damaging the connection between the motor 26 and the power supply.

As the motor 26 may be mounted on the frame 12, the motor 26 may lose connection with the power supply during movement of the frame 12, for example during leveling of the frame 12 by the at least one leveling jack 33. Accordingly, the motor 26 may include a flexible conduit wiring. The flexible conduit wiring is configured to maintain a connection between the motor 26 and the power supply during leveling of the frame 12, for example, during operation of the at least one leveling jack 33. The flexible conduit wiring may be, for example, a flexible housing or hose for containing cables in electrical communication with the motor 26. In some embodiments, the flexible conduit wiring may include a stainless steel braided hose.

As shown in FIGS. 4-6, the removably attachable skimming mechanism 10 is in an attached configuration with the DAF tank 40. In some embodiments, the skimming mechanism 10 is stacked onto the DAF tank 40 and aligned with the DAF tank 40 by an alignment mechanism 14. The alignment mechanism 14 is configured to align the frame 12 with the DAF tank 40 at a time that the frame 12 and the DAF tank 40 are in the attached configuration, at some time when the frame 12 and the DAF tank 40 are in the attached configuration, or at a time of joinder of the frame 12 and the DAF tank 40. The alignment may occur at any one time, or for some time, or for an entirety of the duration that the frame 12 and the DAF tank 40 are in the attached configuration.

The alignment mechanism 14 may automatically align the frame 12 with the DAF tank 40. Alternatively, the alignment mechanism 14 may be operated by a user or controller to align the frame 12 with the DAF tank 40.

The alignment mechanism may be positioned on a surface of the frame 12. For example, as shown in FIGS. 1-3, the alignment mechanism 14 may be a keyway on a surface of the frame 12, facing the DAF tank 40 at a time that the frame 12 and the DAF tank 40 are in the attached configuration.

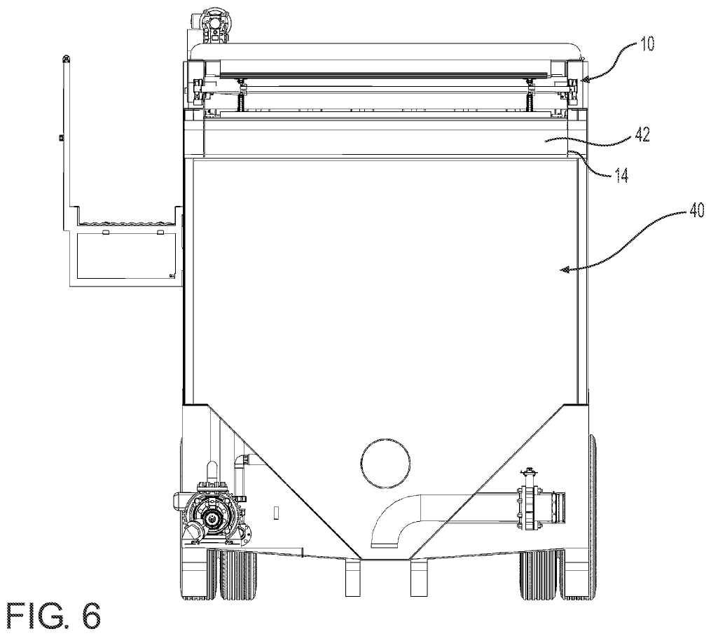

The alignment mechanism 14 may mate with a corresponding mating mechanism 42 of the DAF tank 40. The mating mechanism 42 may be on a surface of the DAF tank 40. For example, as shown in FIG. 6, the mating mechanism 42 is a protrusion extending across a width of the DAF tank 40 on a surface of the DAF tank 40 which faces the frame 12.

The alignment mechanism 14 and the mating mechanism 42 may form a male/female pair. The male piece of the pair may be either the alignment mechanism 14 or the mating mechanism 42. The male piece may include but is not limited to a bolt, a screw, a prong, a river, a stud, a pin, an insert, a protrusion, a nail, a knuckle, a prong, and/or a nipple. The female piece of the pair may be the other of the alignment mechanism 14 or the mating mechanism 42. The female piece may include but is not limited a nut, an aperture, a socket, a perforation, a keyway, an opening, an orifice, a receptacle, a slot, and/or a receiver.

In some embodiments, the alignment mechanism 14 may not be paired with a corresponding mating mechanism 42. For example, the alignment mechanism 14 may be a wedge, a spring, a clamp, a chain, a tie, a hook, a joint, and/or a latch. These embodiments may also be paired with a mating mechanism 42.

In some embodiments, the alignment mechanism 14 may be positioned on a surface of the DAF tank 40. In some embodiments, the mating mechanism 42 may be positioned on a surface of the frame 12.

The frame 12, the DAF tank 40, or portions thereof may form the alignment mechanism 14 and/or the mating mechanism 42. For example, DAF tank 40 may include an orifice configured to fit a portion of or an entirety of the frame 12 or an insert or base attached to the frame 12.

In an attached configuration, a weight of the skimming mechanism 10, the alignment mechanism 14, and/or the mating mechanism 42 may hold the frame 12 in the attached configuration during operation or transportation of the DAF unit.

The frame 12 and/or the DAF tank 40 may further include at least one fastener for reinforcing removable attachment of the frame 12 to the DAF tank 40. The at least one fastener may extend from a surface of the frame 12 and/or DAF tank to a surface of the other of the frame 12 and/or DAF tank 40. The at least one fastener may be, for example, but is not limited to, any of the male/female components described herein, a wedge, a spring, a clamp, a chain, a tie, a hook, a joint, and/or a latch.

The length and/or the width of the frame 12 may be adjustable. For example, the frame 12 may be extendable by an insert or a base, attachably removable from the frame 12 and configured to fit the frame 12 onto the DAF tank 40. Alternatively, the frame 12 may be extendable by a telescoping mechanism where a side of the frame is configured to fold into itself to increase or decrease its length and/or width.

The waste compartment 44 may provide short term storage of waste after removing the waste from the DAF tank 40. In some embodiments, the waste compartment 44 may have a storage capacity of 100-20,000 gallons, 1,000-10,000 gallons, or 2,000-8,000 gallons. Alternatively, the waste compartment 44 may be smaller than 100 gallons, and the waste may be transported, such as by a pump, out of the waste compartment 44 immediately upon entry or at regular intervals.

The skimming mechanism 10 may have a high corrosion resistance and may be composed of, for example, stainless steel. A weight percentage of stainless steel in the skimming mechanism 10, based on a total weight of the skimming mechanism 10, may be greater than a weight percentage of stainless steel in the DAF tank 40, based on a total weight of the DAF tank 40. When determining a weight of the skimming mechanism 10, the determination may include only the frame 12 and the conveyor 20. When determining a weight of the DAF tank 40, the determination may include only a container utilized for storing the fluid.

A primary material of a component refers to a material which makes up the largest weight percentage by mass of the respective component.

A primary material of the skimming mechanism may be, for example, stainless steel. The primary material of the skimming mechanism 10 refers to the primary material of the frame 12 and the conveyor 20.

A primary material of the DAF tank 40 may be mild steel. The mild steel may be coated with a stainless steel to provide corrosion resistance on an exterior the primary material of the DAF tank. The primary material of the DAF tank 40 refers to the primary material of the container utilized for storing the fluid. There may, and likely will, exist other materials used within the DAF tank 40, for example for components of the tank other than those forming the container, and auxiliary (non-primary) materials of the container.

The corrosion resistance of a material, such as stainless steel or mild steel, may be determined by a weight percentage of chromium, nickel, and/or molybdenum, based on a total weight of said component.

The primary material of the skimming mechanism 10 may have a weight percentage of chromium in the range of 5%-35%, 10.5%-29%, or 15%-25%, based on a total weight of the primary material. The primary material of the skimming mechanism 10 may have a weight percentage of nickel in the range of 0%-20%, 3%-14%, or 6%-12%, based on a total weight of the primary material. The primary material of the skimming mechanism 10 may have a weight percentage of molybdenum in the range of 0%-10%, 0.1%-6%, or 0.5%-4%, based on a total weight of the primary material.

In some embodiments, the primary material of the DAF tank 40 may have a weight percentage of chromium in the range of 0%-20%, 0%-10.4%, or 10.5%-14%, based on a total weight of the primary material. The primary material of the DAF tank 40 may have a weight percentage of nickel in the range of 0%-8%, 0.1%-6%, or 1%-4%, based on a total weight of the primary material. The primary material of the DAF tank 40 may have a weight percentage of molybdenum in the range of 0%-4%, 0.01%-3%, or 0.05%-1%, based on a total weight of the primary material.

A weight percentage of at least one of chromium, nickel, and molybdenum in the primary material of the skimming mechanism 10, based on a total weight of the primary material of the skimming mechanism 10, may be greater than a respective weight percentage of the at least one of chromium, nickel, and molybdenum in the primary material of the DAF tank 40, based on a total weight of the primary material of the DAF tank 40.

A weight percentage of at least one of chromium, nickel, and molybdenum in the skimming mechanism 10, based on a total weight of the skimming mechanism 10, may be greater than a respective weight percentage of the at least one of chromium, nickel, and molybdenum in the DAF tank 40, based on a total weight of the DAF tank 40.

The composition of the primary material of the skimming mechanism 10 and the composition of the primary material of the DAF tank 40 are not particularly limited. In some embodiments, polymers (polyethylene, polypropylene, etc.) and composite materials such as fiberglass may also provide corrosion resistance. Alternatively, titanium, aluminum, carbon steel, alloys of such metals, and other metal alloys may be utilized. The composition of the primary material may be determined, for example, based on a fluid to be processed by the DAF unit. In some embodiments, the primary material of the skimming mechanism 10 has a higher corrosion resistance than a primary material of the DAF tank 40.

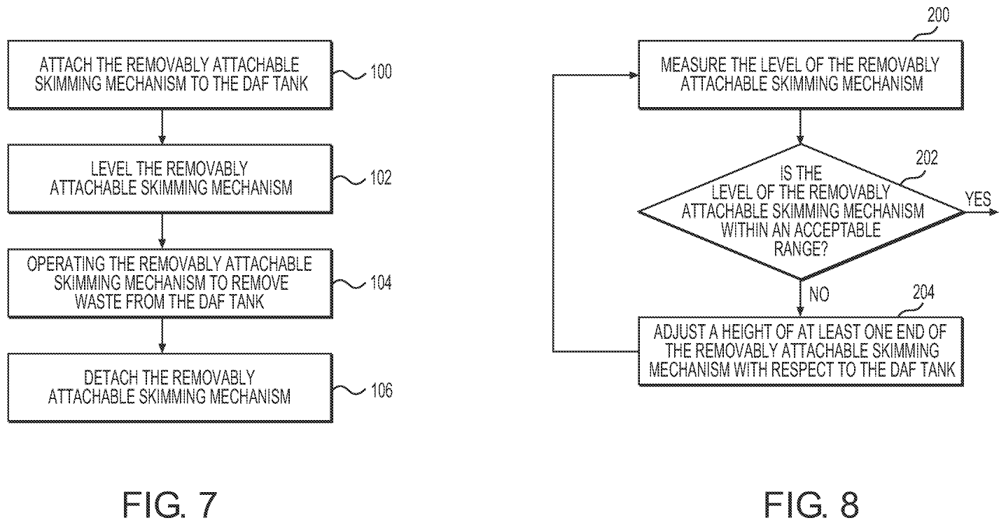

FIG. 7 depicts a method for using the removably attachable skimming mechanism 10 to, for example, perform a fluid treatment process. The removably attachable skimming mechanism 10 may be attached 100 to the DAF tank 40 and thus placed in an attached configuration. The attached configuration may be a beginning configuration of the skimming mechanism 10 and DAF tank 40, or the system may be moved from a detached configuration to the attached configuration via or before the herein described method. At a time while the removably attachable skimming mechanism 10 and the DAF tank 40 are moved into or otherwise are in an attached configuration, the alignment mechanism 14 may align the skimming mechanism 10 to the DAF tank 40. The alignment mechanism 14 may automatically align the skimming mechanism 10 with the DAF tank 40. In some embodiments, the alignment mechanism 14 may be operated by a user or a controller to align the skimming mechanism 10 and the DAF tank 40 at some time while the skimming mechanism 10 and DAF tank 40 are in the attached configuration. For example, the alignment mechanism 14 may be a latch with a switch operated by the user.

In some embodiments, the skimming mechanism 10 and the DAF tank 40 may be fastened by a fastener for reinforcement of the removable attachment. The fastener may fasten the skimming mechanism 10 to the DAF tank 40, for example, after attaching the skimming mechanism 10 to the DAF tank 40. The fastener may be utilized, for example, during transportation of the unit and/or operation of the skimming mechanism 10.

After the skimming mechanism 10 and the DAF tank 40 are attached, the skimming mechanism 10 may be optionally leveled 102.

After the skimming mechanism 10 and the DAF tank 40 are attached, the skimming mechanism 10 may be operated 104 with the motor 26 to remove waste from the DAF tank 40.

The skimming mechanism 10 may be detached 106 from the DAF tank 40, resulting in the skimming mechanism 10 and DAF tank 40 being in the detached configuration. The skimming mechanism 10 may be detached, for example, for maintenance of a component or transportation of the skimming mechanism 10 and/or DAF tank 40. After detachment, the skimming mechanism 10 may be removably attached 100 to the DAF tank 40 again.

FIG. 8 describes the leveling 102 in further detail according to some embodiments. The level of the skimming mechanism 10 may be measured 200. This may be performed by a leveling device or by a visual estimate. The measured level is then compared to an acceptable range 202. If the level of the skimming mechanism is in an acceptable range, the leveling 102 may be completed. If the level is not in an acceptable range, the at least one leveling jack 33 may be raised or lowered to adjust a height of at least one end of the frame 12. After the height is adjusted, the process may be repeated, and the level of the skimming mechanism may be measured 200 again. The process may repeat until the level of the skimming mechanism 10 is in an acceptable range.

In some embodiments, the skimming mechanism 10 may be detached by a fork lift or a train. In some embodiments, when necessary, the skimming mechanism 10 may be removed and placed at ground level or taken off-site. This enables the skimming mechanism 10 to be more easily serviced. In addition, the skimming mechanism 10 may be swapped out for another skimming mechanism 10 during maintenance to reduce operational downtime of the DAF tank 40.

Owing to the instantly described embodiments, if either of the DAF tank 40 or the skimming mechanism 10 were to fail, the skimming mechanism 10 may be detached from the DAF tank 40 and the failed unit may be replaced without requiring replacement or significant change to the other unit.

Thus, because the skimming mechanism 10 and the DAF tank 40 may be separated when one fails, the DAF tank 40 may be built with a lower expected lifetime than that of the skimming mechanism 10. Accordingly, the DAF tank 40 may utilize less anti-corrosive materials, and the DAF tank may be manufactured with a primary material having a lower corrosion resistance than that of the skimming mechanism.

As the skimming mechanism 10 is separable from the DAF tank 40, the entirety of the DAF tank 40 need not be leveled for operation of the DAF unit. Instead, in an attached configuration, the skimming mechanism 10 may be leveled with respect to a fluid in the DAF tank 40, without leveling the DAF tank 40, either by virtue of the at least one leveling jack 33 or otherwise. Thus, a level base or foundation is not required for the DAF tank 40.

As shown in FIGS. 1-6, the skimming mechanism 10 and DAF tank 40 are each rectangular in plan view. However, the shape of the skimming mechanism 10 and/or the DAF tank 40 are not particularly limited. For example, the shape of at least one of the skimming mechanism 10 or DAF tank 40 may be round or polygonal from a plan view. For example, in an embodiment where the DAF tank 40 is circular from plan view, the scraper blades 24 of the skimming mechanism 10 may be configured to rotate circumferentially across or around the DAF tank 40. In some embodiments, the scraper blades 24 only traverse a portion of the DAF tank 40.

More generally, the Figures illustrate the architecture, functionality, and operation of possible implementations of apparatuses and methods according to various embodiments of the present disclosure. In this regard, each block or feature in the Figures may represent a module, segment, or portion of the method or apparatus, and the functions noted therein may occur out of the order noted in the Figures. For example, two blocks or features shown in succession, and corresponding functions and/or methods described herein may, in fact, be executed substantially concurrently, or the blocks or features may sometimes be executed in the reverse order, depending upon the functionality involved.

It will be appreciated that the above-disclosed features and functions, or alternatives thereof, may be desirably combined into different systems and methods. Also, various alternatives, modifications, variations or improvements may be subsequently made by those skilled in the art, and are also intended to be encompassed by the disclosed embodiments. As such, various changes may be made without departing from the spirit and scope of this disclosure.

What is claimed is:

1. A skimming mechanism for treating fluid, the skimming mechanism comprising:
a frame configured to be removably attachable from a dissolved air flotation tank; and
a conveyor traversing a length of the frame, the conveyor including a chain and at least one scraper blade connected to the chain.

2. The skimming mechanism of claim 1, further comprising:
an alignment mechanism provided on a surface of the frame, the alignment mechanism configured to align the frame with the dissolved air flotation tank at a time while the frame and the dissolved air flotation tank are in an attached configuration.

3. The skimming mechanism of claim 1, further comprising at least one leveling jack disposed at an edge of the frame, the at least one leveling jack configured to level the conveyor with respect to a level of fluid in the dissolved air flotation tank at some time while the frame and the dissolved air flotation tank are in an attached configuration.

4. The skimming mechanism of claim 1, further comprising a beach disposed at a predetermined distance from a surface of the frame that is located at a side end of the frame.

5. The skimming mechanism of claim 4, wherein the beach is a ramped surface extending in a direction towards the surface of the frame that is located at the side end of the frame and in a direction away from a fluid in the dissolved air flotation tank at a time while the frame and the dissolved air flotation tank are in an attached configuration.

6. The skimming mechanism of claim 5, further comprising at least one shaft, wherein:
the at least one shaft extends across a width of the frame, and
the at least one shaft is positioned to direct a course of the chain such that the at least one scraper blade runs across the ramped surface of the beach.

7. The skimming mechanism of claim 1, further comprising a motor configured to drive the at least one scraper blade across the length of the frame.

8. The skimming mechanism of claim 7, further comprising a flexible conduit wiring in electrical communication with the motor, wherein the flexible conduit wiring is configured to maintain a connection between the motor and a power supply during leveling of the conveyor.

9. The skimming mechanism of claim 8, wherein the flexible conduit wiring includes a stainless steel braided hose.

10. The skimming mechanism of claim 2, wherein the alignment mechanism is a keyway.

11. A dissolved air flotation system comprising:
a dissolved air flotation tank;
a skimming mechanism including:
a frame configured to be removably attachable from the dissolved air flotation tank;
an alignment mechanism provided on a surface of the frame, the alignment mechanism configured to align the frame with the dissolved air flotation tank at a while that the frame and the dissolved air flotation tank are in an attached configuration; and
a conveyor traversing a length of the frame, the conveyor including a chain and at least one scraper blade connected to the chain;
a motor configured to rotate the conveyor and drive the at least one scraper blade across the length of the frame;
a mating mechanism disposed on a surface of the dissolved air flotation tank, the mating mechanism configured to mate with the alignment mechanism of the frame at a time while the frame and the dissolved air flotation tank are in the attached configuration; and
a waste compartment joined to the dissolved air flotation tank.

12. The dissolved air flotation system of claim 11, further comprising a fastener for reinforcing removable attachment of the frame to the dissolved air flotation tank at some time while the frame and the dissolved air flotation tank are in the attached configuration.

13. The dissolved air flotation system of claim 12, wherein the fastener is at least one bolt extending from the frame to the dissolved air flotation tank.

14. The dissolved air flotation system of claim 12, wherein a primary material of the skimming mechanism has a higher corrosion resistance than a primary material of the dissolved air flotation tank.

15. The dissolved air flotation system of claim 14, wherein a weight percentage of chromium in the primary material of the skimming mechanism is higher than a weight percentage of chromium in a primary material of the dissolved air flotation tank, a weight percentage of chromium in a primary material of a component being based on a total weight of the primary material of the component.

16. The dissolved air flotation system of claim 11, wherein a storage capacity of the waste compartment is in a range of 100 to 20,000 gallons.

17. The dissolved air flotation system of claim 11, further comprising at least one leveling jack disposed between the frame and the dissolved air flotation tank, the at least one leveling jack configured to level the frame with respect to a level of fluid in the dissolved air flotation tank, at some time while the frame and the dissolved air flotation tank are in the attached configuration.

18. A method for treating fluid in a dissolved air flotation system, the method comprising:
attaching a removably attachable skimming mechanism to a dissolved air flotation tank; and
operating the skimming mechanism to treat fluid in the dissolved air flotation tank.

19. The method for treating fluid of claim 18, further comprising:
detaching the removably attachable skimming mechanism from the dissolved air flotation tank.

20. The method for treating fluid of claim 18, further comprising:
after attaching the removably attachable skimming mechanism to the dissolved air flotation tank, leveling the removably attachable skimming mechanism with respect to a level of the fluid in the dissolved air flotation tank without leveling the dissolved air flotation tank.
